(19) United States
(12) Patent Application Publication
(10) Pub. No.: US 2014/0064674 A1
(43) Pub. Date: Mar. 6, 2014

(54) OPTICAL FIBER CONNECTOR

(71) Applicant: HON HAI PRECISION INDUSTRY CO., LTD., New Taipei (TW)

(72) Inventor: I-THUN LIN, New Taipei (TW)

(73) Assignee: HON HAI PRECISION INDUSTRY CO., LTD., New Taipei (TW)

(21) Appl. No.: 13/858,104

(22) Filed: Apr. 8, 2013

(30) Foreign Application Priority Data
Aug. 28, 2012 (TW) 101131260

(51) Int. Cl. G02B 6/43

(52) U.S. Cl. CPC G02B 6/43
USPC 385/89

(57) ABSTRACT

An optical fiber connector includes a body for positioning optical fibers and a coupler for optically aligning the optical fibers with photoelectric elements. One of the body and the coupler includes a positioning plug, and the other of the body and the coupler defines a receiving groove. The positioning plug is substantially rectangular-shaped and includes four first peripheral alignment surfaces. The receiving groove includes four second inner alignment surfaces. The positioning plug is received in the receiving groove, with the first peripheral alignment surfaces respectively attached on the second inner alignment surfaces when the body and the coupler are connected to each other.

### BACKGROUND

1. Technical Field

The present disclosure relates to connectors and, particularly, to an optical fiber connector for an optical communication apparatus.

2. Description of Related Art

Optical fiber connectors are configured for connecting optical fibers to photoelectric elements. The optical fiber connector generally includes a body for positioning the optical fibers, and a coupler connected to the body for optically aligning the optical fibers with the photoelectric elements. To reduce insertion loss, the body and the coupler are required to be positioned precisely. The body includes a number of cone-shaped engaging posts and the coupler defines a number of cone-shaped engaging grooves corresponding to the engaging posts. The body and the coupler are aligned with each other by engagement between the posts and the grooves. However, it is difficult to produce the optical fiber connector with the cone-shaped engaging posts and engaging grooves. Furthermore, the producing precision of the engaging posts and the engaging grooves is difficult to be ensured.

What is needed therefore is an optical fiber connector addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an isometric view of an optical fiber connector, according to an exemplary embodiment of the present disclosure.

FIG. 2 is an exploded view of the optical fiber connector FIG. 1.

FIG. 3 is similar to FIG. 2, but showing the optical fiber connector from another angle.

FIG. 4 is similar to FIG. 2, but showing the optical fiber connector from another angle.

FIG. 5 is a cross-sectional view of the optical fiber connector of FIG. 1, taken along line V-V.

### DETAILED DESCRIPTION

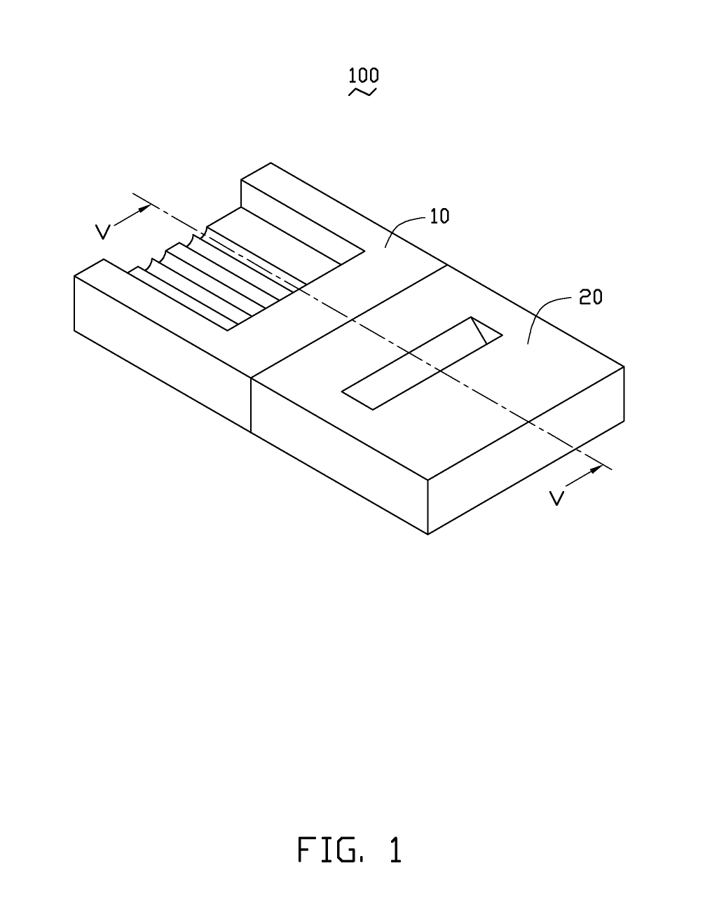

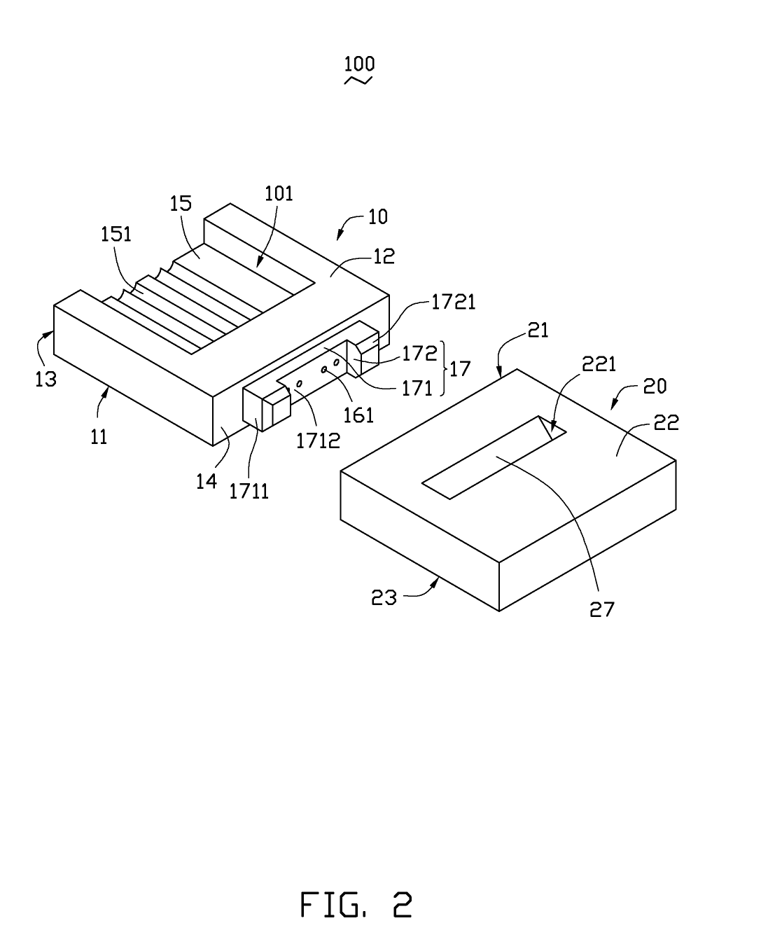

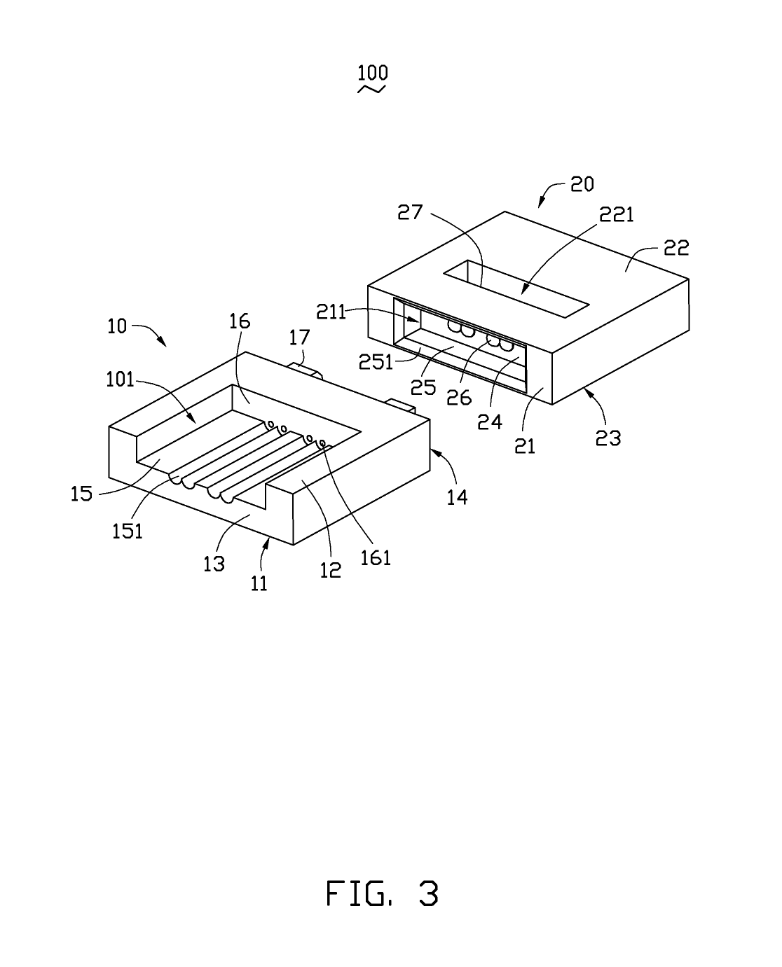

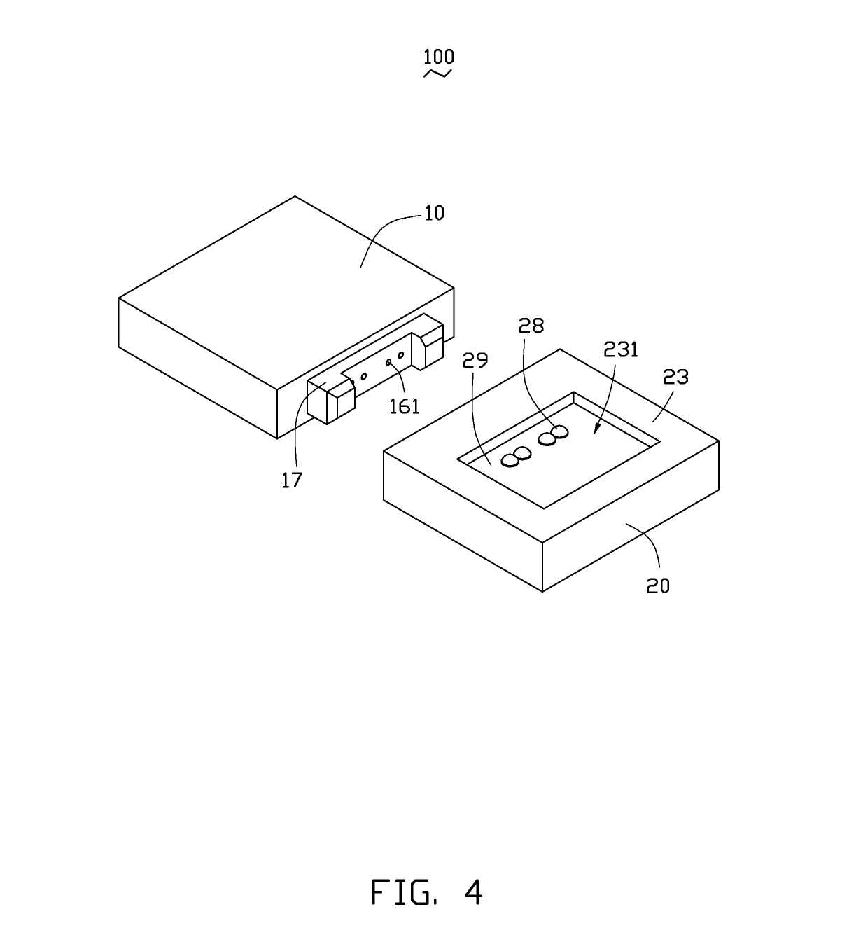

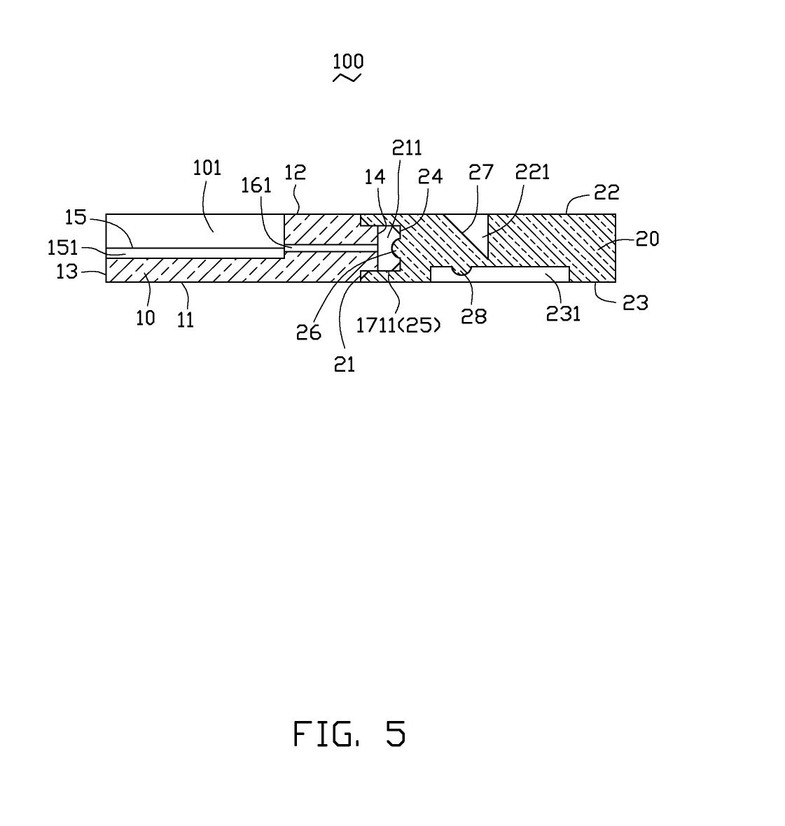

FIGS. 1-5 show an optical fiber connector 100 according to an exemplary embodiment. The optical fiber connector 100 is configured for connecting a number of optical fibers (not shown) to a number of photoelectric elements (not shown), respectively. The optical fiber connector 100 includes a body 10 for positioning the optical fibers, and a coupler 20 connected to the body 10 for optically aligning the optical fibers with the photoelectric elements.

The body 10 is substantially rectangular-shaped. The body 10 includes a bottom surface 11, a top surface 12 opposite to the bottom surface 11, a first end surface 13, and a second end surface 14 opposite to the first end surface 13. The bottom surface 11 is substantially parallel to the top surface 12, the first end surface 13 is substantially parallel to the second end surface 14, and the top surface 11 and the bottom surface 12 are substantially perpendicular to the first end surface 13 and the second end surface 14.

The body 10 defines a first groove 101. The first groove 101 passes through the top surface 12 and the first end surface 13, and forms a first surface 15 and a second surface 16 in the body 10. The first surface 15 is substantially parallel to the bottom surface 11, and the second surface 16 is substantially parallel to the second end surface 14. The body 10 defines a number of positioning grooves 151 in the first surface 15, and each positioning groove 151 is configured for positioning an optical fiber therein. The body 10 further defines a number of fixing holes 161 in the second surface 16 spatially corresponding to the positioning groove 151, and each fixing hole 161 is configured for fixing an end of an optical fiber therein. In this embodiment, the fixing holes 161 are through holes.

The body 10 includes a positioning plug 17 protruding from the second end surface 14. The positioning plug 17 includes a base portion 171 and two protrusions 172 protruding from the base portion 171 along a direction substantially perpendicular to the second end surface 14. The base portion 171 is substantially rectangular-shaped. The base portion 171 includes four peripheral first alignment surfaces 1711 substantially perpendicular to the second end surface 14, and a light emergent surface 1712 substantially parallel to the second end surface 14. The fixing holes 161 passes through the light emergent surface 1712. The protrusions 172 are formed on two opposite sides of the light emergent surface 1712, respectively. Each protrusion 172 is substantial a quadrangular prism. Each protrusion 172 includes a first tapered portion 1721 formed on a distal end thereof.

The coupler 20 is substantially rectangular-shaped. The coupler 20 includes a third end surface 21 facing toward the body 10, an upper surface 22, and a lower surface 23 opposite to the upper surface. The upper surface 22 is substantially parallel to the lower surface 23, and the third end surface 21 is substantially perpendicular to the upper surface 22 and the lower surface 23.

The coupler 20 defines a receiving groove 211 in the third end surface 21. A shape and size of the receiving groove 211 correspond to the shape and size of the positioning plug 17. The receiving groove 211 forms four peripheral second alignment surfaces 25 corresponding to the first alignment surfaces 1711, and a first bottom interface 24. The coupler 20 includes a number of first lens portions 26 formed on the first bottom interface 24. Each lens portion 26 is corresponding to a fixing hole 161. In this embodiment, the first lens portions 26 are convex lenses, and the first lens portions 26 are integrally formed with the first bottom interface 24. The second alignment surfaces 25 cooperatively form a second tapered portion 251 at a side of the receiving groove 211 facing toward the body 10.

The coupler 20 defines a second groove 221 in the upper surface 22. The groove 221 forms a reflecting surface 27 in the coupler 20 to reflect light for a predetermined angle. In this embodiment, an included angle between the reflecting surface 27 and an optical axis of each first lens 26 is substantially 45 degrees, and the reflecting surface 27 reflects light for substantially 90 degrees.

The coupler 20 defines a third groove 231 in the lower surface 23. The third groove 231 forms a second bottom interface 29 in the coupler 20. The second bottom interface 29 is substantially perpendicular to the first bottom interface 24. The coupler 20 includes a number of second lens portions 28 formed on the second bottom interface 29 corresponding to the first lens portions 26. In this embodiment, an included angle between an optical axis of each second lens portion 28 and the reflecting surface 27 is substantially 45 degrees. The second lens portions 28 are convex lenses, and the second lens portions 28 are integrally formed with the bottom surface of the third groove 231.

In assembly, the positioning plug 17 is engaged into the receiving groove 211, and the first alignment surfaces 1711 are attached to the second alignment surfaces 25, respectively. The first tapered portions 1721 and the second tapered portion 241 can prevent the first alignment surfaces 1711 and the second alignment surfaces 25 from hitting each other during the assembly. Because the first alignment surfaces 1711 are peripheral surfaces of the rectangular-shaped positioning plug 17, and the second alignment surfaces 25 are inner surfaces of the rectangular-shaped receiving groove 211, therefore, it is easy to produce the first and second alignment surfaces 1711, 25, and the precision of the first and second alignment surfaces 1711, 25 can be ensured.

In an optical communication apparatus, the coupler 20 is positioned on a printed circuit board (not shown) which includes a number of photoelectric elements (not shown) corresponding to the second lens portions 28. Each second lens portion 28 is optically aligned with a corresponding photoelectric element. In this embodiment, the photoelectric elements include two optical signal emitters and two optical signal receivers. The optical signal emitters can be laser diodes, and the optical signal receivers can be photo diodes.

In this embodiment, the positioning plug 17 is formed on the body 10, and the receiving groove 211 is defined in the coupler 20. Alternatively, the positioning plug 17 can be formed on the coupler 20, and the receiving groove 211 can be defined in the body 10. In this case, the fixing holes 161 pass thorough a bottom surface of the receiving groove 211, and the first lens portions 26 are formed on an end surface of the positioning plug 27.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An optical fiber connector for connecting optical fibers to photoelectric elements, comprising:
a body configured for positioning the optical fibers; and
a coupler connected to the body, the coupler being configured for optically aligning the optical fibers with the photoelectric elements;
wherein on of the body and the coupler comprises a positioning plug, the other of the body and the coupler defines a receiving groove, the positioning plug is substantially rectangular-shaped, the positioning plug comprises four first peripheral alignment surfaces, the receiving groove comprises four second inner alignment surfaces corresponding to the first peripheral alignment surfaces, and the positioning plug is received in the receiving groove, with the first peripheral alignment surfaces respectively attached on the second inner alignment surfaces when the body and the coupler are connected to each other.

2. The optical fiber connector of claim 1, wherein the positioning plug comprises a base portion and two protrusions protruding from the base portion, and the protrusions are positioned at two opposite sides of a surface of the base portion.

3. The optical fiber connector of claim 2, wherein each protrusion comprises a first tapered portion on its distal end, the second alignment surfaces cooperatively form a second tapered portion at a side of the receiving groove facing toward the positioning plug, and the second tapered portion touches the first tapered portion of each protrusion when the body and the coupler are connected to each other.

4. The optical fiber connector of claim 1, wherein the body comprises a bottom surface, a top surface opposite to the bottom surface, a first end surface, and a second end surface opposite to the first end surface, the bottom surface is substantially parallel to the top surface, the first end surface is substantially parallel to the second end surface, and the top surface and the bottom surface are substantially perpendicular to the first end surface and the second end surface.

5. The optical fiber connector of claim 4, wherein the body defines a first groove therein, the first groove passes through the top surface and the first end surface and forms a first surface and a second surface in the body, the first surface is substantially parallel to the bottom surface, and the second surface is substantially parallel to the second end surface.

6. The optical fiber connector of claim 5, wherein the body defines a number of positioning grooves in the first surface and a number of fixing holes in the second surface spatially corresponding to the positioning groove, each positioning groove is configured for positioning an optical fiber therein, and each fixing hole is configured for receiving an end of an optical fiber.

7. The optical fiber connector of claim 6, wherein the positioning plug is positioned on the second end surface of the body, and the fixing holes pass through the positioning plug.

8. The optical fiber connector of claim 1, wherein the coupler comprises a third end surface facing toward the body, an upper surface, and a lower surface opposite to the upper surface, the upper surface is substantially parallel to the lower surface, and the third end surface is substantially perpendicular to the upper surface and the lower surface.

9. The optical fiber connector of claim 8, wherein the receiving groove is defined in the third end surface and forms a first bottom interface in the coupler.

10. The optical fiber connector of claim 9, wherein the coupler defines a second groove in the upper surface, the second groove forms a reflecting surface in the coupler for reflecting light for a predetermined angle.

11. The optical fiber connector of claim 10, wherein the coupler defines a third groove in the lower surface, and the third groove forms a second bottom interface in the coupler.

12. The optical fiber connector of claim 11, wherein the coupler comprises a plurality of first lens portions on the first bottom interface and a plurality of second lens portions on the second bottom interface corresponding to the first lens portions, an optical axis of each first lens portion is substantially perpendicular to an optical axis of each second lens portion, and an included angle between the optical axis of each first lens portion or each second lens portion and the reflecting surface is substantially 45 degrees.
